(19) United States
(12) Patent Application Publication
(10) Pub. No.: US 2013/0013413 A1
(43) Pub. Date: Jan. 10, 2013

(54) SYSTEM AND METHOD FOR ADVERTISING TO DRIVERS

(76) Inventor: Gerald Lynn McDaniel, Roanoke Rapids, NC (US)

(21) Appl. No.: 13/178,573

(22) Filed: Jul. 8, 2011

(51) Int. Cl. G06Q 30/00; G06Q 90/00

(52) U.S. Cl. 705/14.64; 705/500; 705/14.49

(57) ABSTRACT

The present invention relates to an advertising method for reaching drivers who utilize the Toll Road System. By utilizing toll info on a driver as the toll is paid, advertisers can target the driver based on their location and can offer toll reimbursement in return for visiting or utilizing an advertiser's product or service.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and system for advertising to drivers utilizing the toll road system. In particular the present invention relates to providing advertising to people utilizing the toll system based on their frequency and/or location of use of the toll system.

2. Description of Related Art

The art of advertising to drivers has been a fixture of Americana since before Burma Shave Road advertisements adorned US highways and rhymed their way into history. The idea of advertising to those who drive automobiles is an attractive one since people drive certain places regularly and frequently buy similar products including items for the car they drive.

The advertisements to automobile drivers conventionally take on two approaches. One involves placing advertisements along the roadway letting the driver know about either upcoming locations of interest or of general concepts or direct marketing advertising to the owners of vehicles, for example by mail or e-mail. The first, while locationally relevant, does not address the frequency that a driver passes a point. The second does neither and just address the receiver based on “you own a vehicle”.

Toll booths along highways tend to collect tolls via individuals manning tollbooths where in many cases as long as the toll is collected, no active list of users is available in most cases. Frequently, however, license plates are videoed or otherwise noted so that if desired, an identity and frequency can be compiled. More recently, electronic detection systems are being introduced such that tolls are collected from an account when the vehicle passes a particular point and the vehicle is identified by an electronic device in the vehicle. A record of all tolls is collected for each car including the location and time of the toll presence for collection by mail, electronically, or other method.

### BRIEF SUMMARY OF THE INVENTION

The present invention takes advantage of the toll system and provides a system for utilizing the information collected at toll collection points to advertise to drivers electronically, more particularly, direct advertising either to a locationally based driver or to one who frequents a particular tool collection point location. In addition, it is a memo for advertisers to provide toll reimbursement or validation payment for utilizing the advertiser's service.

Accordingly in one embodiment of the invention there is a method for advertising to a driver of a motor vehicle comprising:
a) identifying a motor vehicle associated with paying a road toll along a motor vehicle highway having a toll collection system; and
b) providing a directed advertisement to the driver of the vehicle based on a toll parameter of a payment of the road toll.

### BRIEF DESCRIPTION OF THE DRAWINGS

FIG. 1 is flow chart of a method of the present invention.

FIG. 2 is a flow chart of a specific example of the present invention.

FIG. 3 is a relationship chart of the players involved in the particular invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “advertising” refers to any type of commercial promotion of a product or service. The advertisement can be electronic in the form of a text message, an e-mail, internet communication, Tweet, social network communication, phone call, or the like. It can also be a non-electronic communication such as a flyer, regular mail, or a coupon intended to communicate an offer for such product or service. Since the advertisement is directed to a driver (a “directed advertisement”), the advertisement in one embodiment can be a driver tailored advertisement, that is, designed to be useful for the driver. For example, where the driver is close to a gasoline station, gasoline could be advertised. Where the driver passes a point on a regular basis, car repair or services such as a car wash could be advertised. Discounts on services could also be utilized and one skilled in the art could find different advertisements to promote to a driver in view of the disclosure herein.

In one embodiment of the advertisement the advertiser could advertise a discount on tolls paid by the advertiser in response to purchasing a product or service offered by the advertiser. In other embodiments such a discount could be offered just for visiting the advertiser's place of business. In one embodiment of the present invention, the advertiser pays all or part of the driver's toll in return for visiting the advertiser or utilizing the advertiser's product or service. The toll reimbursement could be handled by a third party facilitator who takes the toll from the advertiser and pays (reimburses) the driver while taking out a fee paid to the facilitator. Reimbursement can be by a convinient means including, but not limited to, cash, check, phone credit, and the like.

As used herein a “motor vehicle” refers to any vehicle that is capable of utilizing the toll road system. Examples of motor vehicles within the scope of the invention are automobiles, trucks, motorcycles, buses and the like while vehicles like golf carts and the like would not be motor vehicles within the scope of the invention. Each of these has an identified driver that operates the vehicle.

As used herein “identifying a motor vehicle associated with paying a toll along a motor vehicle highway” refers to identification of a vehicle that will/is/has paid a toll along a highway. The motor vehicles above fit that category when traveling the toll road system. A “toll collection system” refers to either a manual or electronic collection system. A manual collection system is where coins or credit cards are used wherein the driver of the motor stops at either an attended or unattended “toll booth”. The identification of the motor vehicle at such a location can be either manual, such as writing down the information, or electronic where a camera or other device scans the license plate. Electronic methods include the use of a vehicle sensor which notes that a vehicle has passed a particular point based on a reader sensing the sensor. Since a sensor will be associated with a particular vehicle, the vehicle can automatically be identified as being at a particular toll collection point of payment.

As used herein a “toll parameter of the toll payment” refers to information about the payment of a toll by the driver of the motor vehicle. The toll parameter can be the location of the payment of the toll, such as the toll booth and its location on the highway system. Thus the parameter would tell an advertiser how far away the driver is from a particular business or service. In other embodiments the toll parameter is the frequency of passing a particular toll collection point. For example, where a business person passes the same point Monday through Friday at the same time an advertiser would deduce that the vehicle was someone going to work rather than someone passing through the area on vacation and could target advertisements accordingly. On the other hand an out of state traveler that passed in one direction on a date and then in the opposite a week later could be deduced to be a vacationer and an appropriate advertisement targeted to that automobile.

The method of the particular advertisement method involves first identifying the vehicle using one of the above methods and then providing a directed advertisement to the driver of the vehicle by a desired method based on a toll parameter of the toll payment.

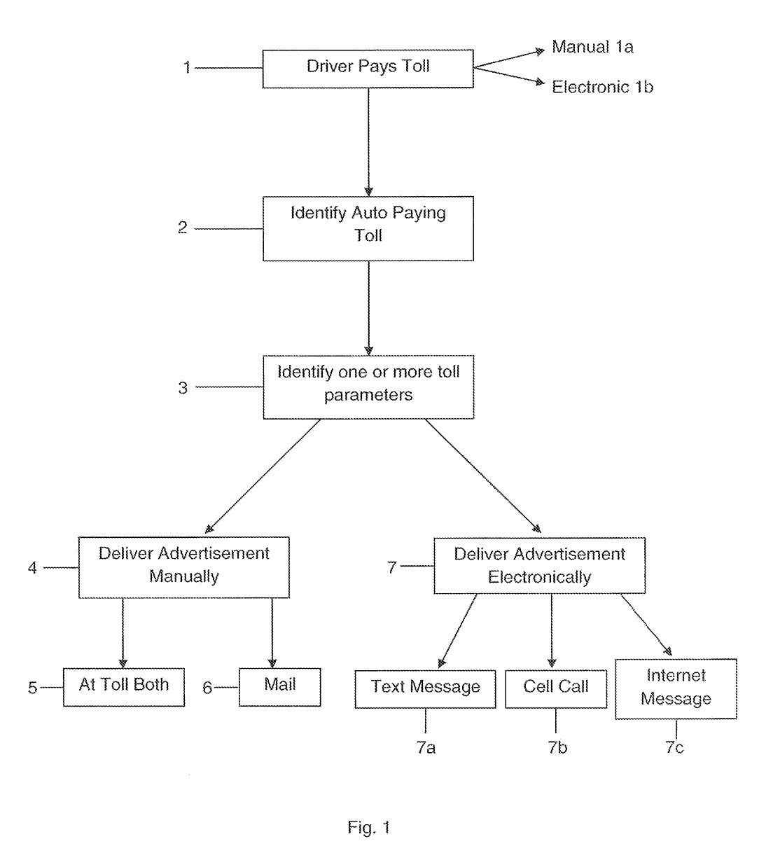

Now referring to the figures of the present invention. FIG. 1 is a flow chart of the present invention. The driver of a motor vehicle comes to a toll collection location and the driver pays a toll 1 by either manual 1a or electronic 1b methods. Upon the payment of the toll, the driver can be identified 2. That is the location, and/or time of the toll payment can be determined by the toll parameters 3. Once identified, the advertisement can be delivered manually 4 such as handing an advertisement by the toll booth operator or by picking one up at a toll booth 5 or getting one in the mail 6. The advertisement can also be delivered electronically 7. Methods include, but are not limited to, text message 7a, cell phone call 7b, and internet message 7c (such as an e-mail).

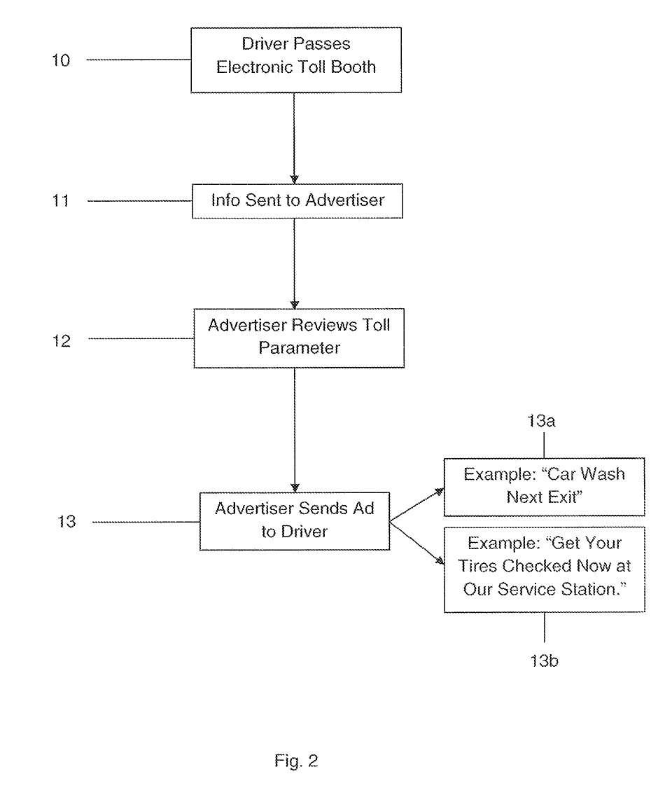

In FIG. 2 a version utilizing an electronic toll booth is utilized. In this embodiment the driver of a motor vehicle passes an electronic toll booth 10 which identifies the automobile and that a toll is due for either later billing or auto withdrawal from an account. Next, in order for the information to be useful to the advertiser, the information is sent to the advertiser 11. This can be done automatically where electronic signals are sent to the advertiser or manually such as phone calls, e-mails, or lists. In one embodiment the entire process of toll collection and notification is done electronically.

Next the advertiser takes the information sent the advertiser and reviews the toll parameters 12 to determine where the driver is, or what time or how frequently the particular toll collection point is passed. Then based on consideration of the toll parameter, the advertiser sends an advertisement to the driver 13. Examples of such simple ads that could be text messages are shown in 13a and 13b.

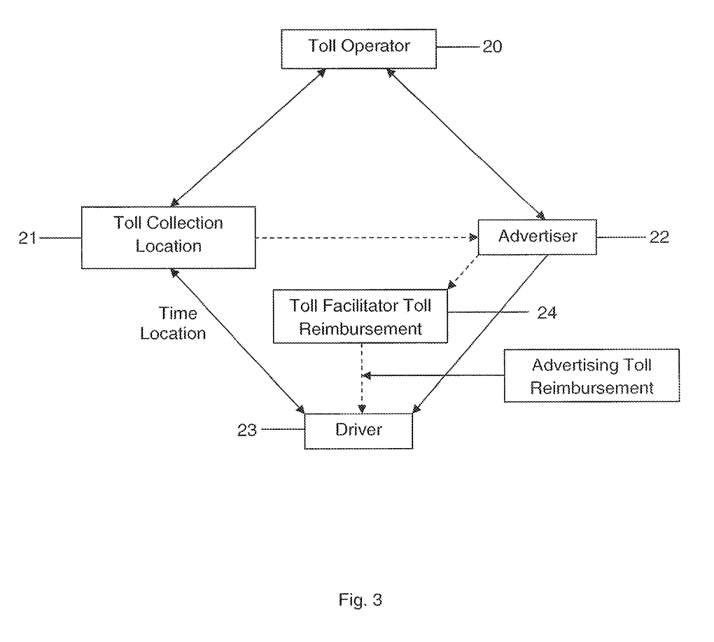

The relationship between the parties is shown in FIG. 3. A toll operator 20 is a particular state, city, or federal government, or an entity working for that government entity. The toll operator 20 operates one or more toll collection locations 21. The toll operator 20 signs or otherwise contracts with a particular advertiser 22 perhaps at no cost to the advertiser, for a percentage of the profits, or the like to create a toll operator/advertiser relationship. The driver 23 of a motor vehicle engages the toll collection location 21 for toll payment and then the location 21 sends (dotted line) the toll collection parameters to the advertiser 22. This is followed by the advertiser 22 sending the driver 23 the advertisement and optimally at least a partial toll reimbursement. In one embodiment advertiser 22 sends toll payment (plus optional commission) to a facilitator 24 who then takes their commission and sends the toll to driver 23.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method for advertising to a driver of a motor vehicle comprising:
a) identifying a motor vehicle associated with paying a road toll along a motor vehicle highway having a toll collection system; and
b) providing a directed advertisement to the driver of the vehicle based on a toll parameter of a payment of the road toll.

2. The method according to claim 1 wherein the vehicle is identified manually at a toll collection location.

3. The method according to claim 1 wherein the vehicle is identified by electronic identification as the vehicle triggers a wireless toll sensor at a toll collection location.

4. The method according to claim 1 wherein the toll parameter is based on the location of the toll payment.

5. The method according to claim 4 wherein the advertisement is for a good or service in the vicinity of or that the driver is heading toward which is determined on the location of the toll payment.

6. The method according to claim 1 which further comprises an advertisement based on the time of the toll payment.

7. The method according to claim 1 wherein the toll parameter is the frequency that the vehicle pays a toll at an individual toll payment location.

8. The method according to claim 1 wherein the advertisement is delivered to the driver at a toll booth.

9. The method according to claim 1 wherein the advertisement is delivered wirelessly to the driver.

10. The method according to claim 1 wherein the advertisement is delivered to the driver via an internet delivery system.

11. The method according to claim 1 wherein the advertiser reimburses at least a portion of the toll for visiting the advertiser.

12. The method according to claim 11 wherein there is a facilitator who handles receiving toll reimbursement from the advertiser and pays the driver the toll reimbursement.
